(19) United States
(12) Patent Application Publication
(10) Pub. No.: US 2017/0097684 A1
(43) Pub. Date: Apr. 6, 2017

(54) Compressed Sensing for Gesture Tracking and Recognition with Radar

(71) Applicant: Google, Inc., Mountain View, CA (US)

(72) Inventor: Jaime Lien, Mountain View, CA (US)

(21) Appl. No.: 15/267,181

(22) Filed: Sep. 16, 2016

Related U.S. Application Data
(60) Provisional application No. 62/237,975, filed on Oct. 6, 2015.
(60) Provisional application No. 62/237,750, filed on Oct. 6, 2015.

(51) Int. Cl. G06F 3/01

(52) U.S. Cl. CPC G06F 3/017

(57) ABSTRACT

This document describes techniques using, and devices embodying, radar-based gesture recognition using compressed sensing. These techniques and devices can enable a great breadth of gestures and uses for those gestures, such as gestures to use, control, and interact with computing and non-computing devices, from software applications to refrigerators. The techniques and devices are capable of providing a radar field that can sense gestures from multiple actors at one time and through obstructions using compressed sensing, thereby improving gesture breadth and accuracy over many conventional techniques using less complex components.

### PRIORITY APPLICATION

This application claims priority under 35 U.S.C. §119(e) to U.S. Provisional Patent Application No. 62/237,975, entitled “Signal Processing and Gesture Recognition” and filed on Oct. 6, 2015, and U.S. Provisional Patent Application No. 62/237,750, entitled “Standard RF Signal Representations for Interaction Applications” and filed on Oct. 6, 2015, the disclosures of which are incorporated in their entirety by reference herein.

### BACKGROUND

Use of gestures to interact with computing devices has become increasingly common. Gesture recognition techniques have successfully enabled gesture interaction with devices when these gestures are made to device surfaces, such as touch screens for phones and tablets and touch pads for desktop computers. Users, however, are more and more often desiring to interact with their devices through gestures not made to a surface, such as a person waving an arm to control a video game. These in-the-air gestures are difficult for current gesture recognition techniques to accurately recognize.

### SUMMARY

This document describes techniques and devices for radar-based gesture recognition via compressed sensing. These techniques and devices can accurately recognize gestures that are made in three dimensions, such as in-the-air gestures. These in-the-air gestures can be made from varying distances, such as from a person sitting on a couch to control a television, a person standing in a kitchen to control an oven or refrigerator, or millimeters from a desktop computer's display.

Furthermore, the described techniques may use a radar field combined with compressed sensing to identify gestures, which can improve accuracy by differentiating between clothing and skin, penetrating objects that obscure gestures, and identifying different actors.

At least one embodiment provides a method for providing, by an emitter of a radar system, a radar field; receiving, at a receiver of the radar system, one or more reflection signals caused by a gesture performed within the radar field; digitally sampling the one or more reflection signals based, at least in part, on compressed sensing to generate digital samples; analyzing, using the receiver, the digital samples at least by using one or more sensing matrices to extract information from the digital samples; and determining the gesture using the extracted information.

At least one embodiment provides a method for providing, using an emitter of a device, a radar field; receiving, at the device, a reflection signal from interaction with the radar field; processing, using the device, the reflection signal by: acquiring N random samples of the reflection signal over a data acquisition window based, at least in part, on compressed sensing; and extracting information from the N random samples signal by applying one or more sensing matrices to the N random samples; determining an identify of an actor causing the interaction with the radar field; determining a gesture associated with the interaction based, at least in part, on the identity of the actor; and passing the determined gesture to an application or operating system.

At least one embodiment provides a radar-based gesture recognition system comprising: a radar-emitting element configured to provide a radar field; an antenna element configured to receive reflections generated from interference with the radar field; an analog-to-digital (ADC) converter configured to capture digital samples based, at least in part, on compressed sensing; and at least one processor configured to process the digital samples sufficient to determine a gesture associated with the interference by extracting information from the digital samples using one or more sensing matrices.

This summary is provided to introduce simplified concepts concerning radar-based gesture recognition, which is further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of techniques and devices for radar-based gesture recognition using compressed sensing are described with reference to the following drawings. The same numbers are used throughout the drawings to reference like features and components:

FIG. 1 illustrates an example environment in which radar-based gesture recognition using compressed sensing can be implemented.

FIG. 2 illustrates the radar-based gesture recognition system and computing device of FIG. 1 in detail.

FIG. 3 illustrates example signal processing techniques that can be used to process radar signals.

FIG. 4 illustrates how an example signal can be represented in various domains.

FIG. 5 illustrates an example signal approximation that can be used in radar-based gesture recognition via compressed sensing.

FIG. 6 illustrates an example method enabling radar-based gesture recognition, including by determining an identity of an actor in a radar field.

FIG. 7 illustrates an example radar field and three persons within the radar field.

FIG. 8 illustrates an example method enabling radar-based gesture recognition using compressed sensing through a radar field configured to penetrate fabric but reflect from human tissue.

FIG. 9 illustrates a radar-based gesture recognition system, a television, a radar field, two persons, and various obstructions, including a couch, a lamp, and a newspaper.

FIG. 10 illustrates an example arm in three positions and obscured by a shirt sleeve.

FIG. 11 illustrates an example computing system embodying, or in which techniques may be implemented that enable use of, radar-based gesture recognition using compressed sensing.

### DETAILED DESCRIPTION

Overview

This document describes techniques using, and devices embodying, radar-based gesture recognition using compressed sensing. These techniques and devices can enable a great breadth of gestures and uses for those gestures, such as gestures to use, control, and interact with various devices, from desktops to refrigerators. The techniques and devices are capable of providing a radar field that can sense gestures from multiple actors at one time and through obstructions, thereby improving gesture breadth and accuracy over many conventional techniques. These devices incorporate compressed sensing to digitally capture and analyze radar signals, and subsequently lower data processing costs (e.g., memory storage, data acquisition, central processing unit (CPU) processing power, etc.). This approach additionally allows radar-gesture recognition to be employed in various devices ranging from devices with relatively high resources and processing power to devices from relatively low resources and processing power.

This document now turns to an example environment, after which example radar-based gesture recognition systems and radar fields, example methods, and an example computing system are described.

Example Environment

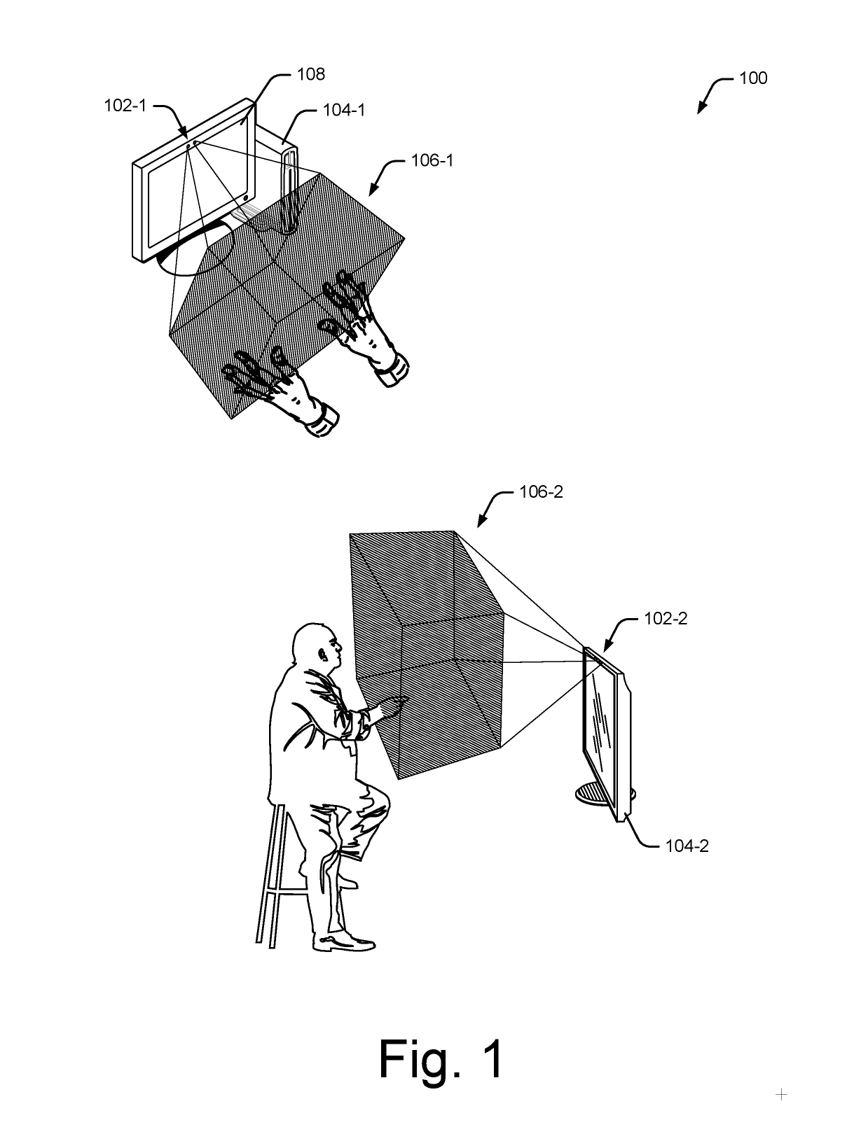

FIG. 1 is an illustration of example environment 100 in which techniques using, and an apparatus including, a radar-based gesture recognition system using compressed sensing may be embodied. Environment 100 includes two example devices using radar-based gesture recognition system 102. In the first, radar-based gesture recognition system 102-1 provides a near radar field to interact with one of computing devices 104, desktop computer 104-1, and in the second, radar-based gesture recognition system 102-2 provides an intermediate radar field (e.g., a room size) to interact with television 104-2. These radar-based gesture recognition systems 102-1 and 102-2 provide radar fields 106, near radar field 106-1 and intermediate radar field 106-2, and are described below.

Desktop computer 104-1 includes, or is associated with, radar-based gesture recognition system 102-1. These devices work together to improve user interaction with desktop computer 104-1. Assume, for example, that desktop computer 104-1 includes a touch screen 108 through which display and user interaction can be performed. This touch screen 108 can present some challenges to users, such as needing a person to sit in a particular orientation, such as upright and forward, to be able to touch the screen. Further, the size for selecting controls through touch screen 108 can make interaction difficult and time-consuming for some users. Consider, however, radar-based gesture recognition system 102-1, which provides near radar field 106-1 enabling a user's hands to interact with desktop computer 104-1, such as with small or large, simple or complex gestures, including those with one or two hands, and in three dimensions. As is readily apparent, a large volume through which a user may make selections can be substantially easier and provide a better experience over a flat surface, such as that of touch screen 108.

Similarly, consider radar-based gesture recognition system 102-2, which provides intermediate radar field 106-2. Providing a radar-field enables a user to interact with television 104-2 from a distance and through various gestures, ranging from hand gestures, to arm gestures, to full-body gestures. By so doing, user selections can be made simpler and easier than a flat surface (e.g., touch screen 108), a remote control (e.g., a gaming or television remote), and other conventional control mechanisms.

Radar-based gesture recognition systems 102 can interact with applications or an operating system of computing devices 104, or remotely through a communication network by transmitting input responsive to recognizing gestures. Gestures can be mapped to various applications and devices, thereby enabling control of many devices and applications. Many complex and unique gestures can be recognized by radar-based gesture recognition systems 102, thereby permitting precise and/or single-gesture control, even for multiple applications. Radar-based gesture recognition systems 102, whether integrated with a computing device, having computing capabilities, or having few computing abilities, can each be used to interact with various devices and applications.

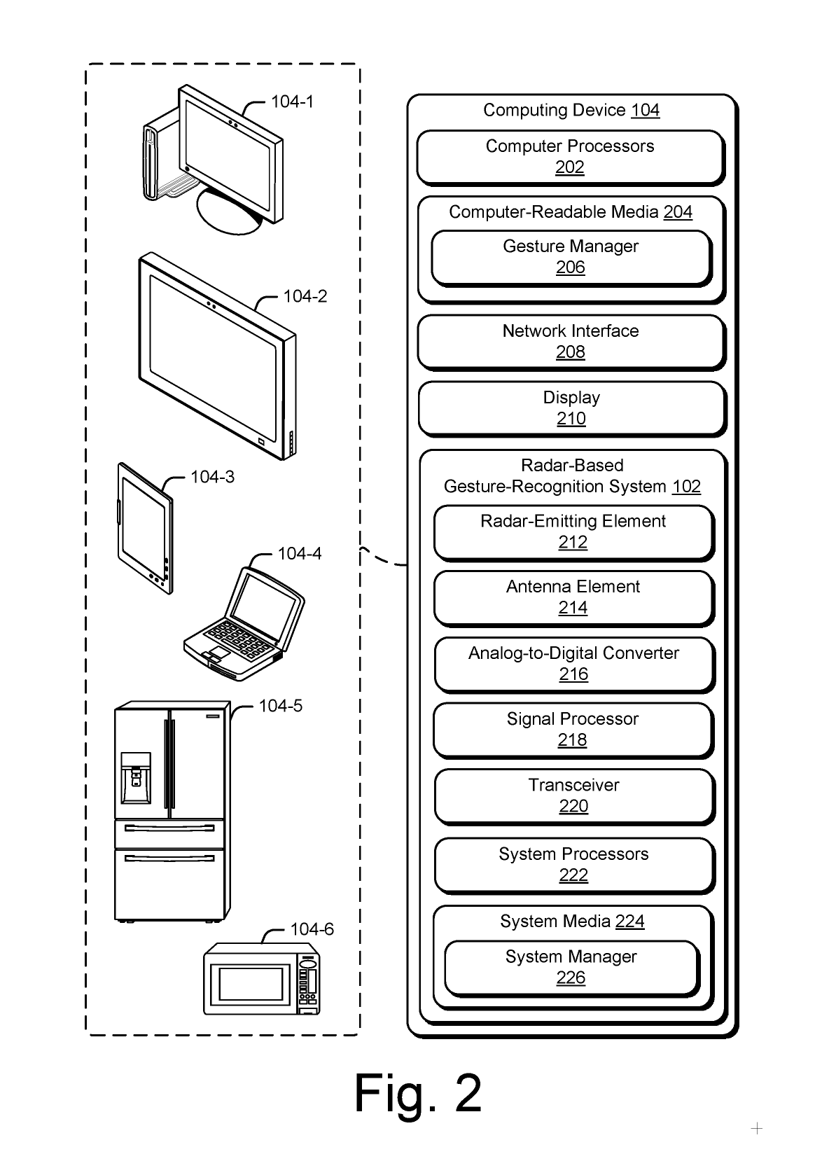

In more detail, consider FIG. 2, which illustrates radar-based gesture recognition system 102 as part of one of computing device 104. Computing device 104 is illustrated with various non-limiting example devices, the noted desktop computer 104-1, television 104-2, as well as tablet 104-3, laptop 104-4, refrigerator 104-5, and microwave 104-6, though other devices may also be used, such as home automation and control systems, entertainment systems, audio systems, other home appliances, security systems, netbooks, smartphones, and e-readers. Note that computing device 104 can be wearable, non-wearable but mobile, or relatively immobile (e.g., desktops and appliances).

Note also that radar-based gesture recognition system 102 can be used with, or embedded within, many different computing devices or peripherals, such as in walls of a home to control home appliances and systems (e.g., automation control panel), in automobiles to control internal functions (e.g., volume, cruise control, or even driving of the car), or as an attachment to a laptop computer to control computing applications on the laptop.

Further, radar field 106 can be invisible and penetrate some materials, such as textiles, thereby further expanding how the radar-based gesture recognition system 102 can be used and embodied. While examples shown herein generally show one radar-based gesture recognition system 102 per device, multiples can be used, thereby increasing a number and complexity of gestures, as well as accuracy and robust recognition.

Computing device 104 includes one or more computer processors 202 and computer-readable media 204, which includes memory media and storage media. Applications and/or an operating system (not shown) embodied as computer-readable instructions on computer-readable media 204 can be executed by processors 202 to provide some of the functionalities described herein. Computer-readable media 204 also includes gesture manager 206 (described below).

Computing device 104 may also include network interfaces 208 for communicating data over wired, wireless, or optical networks and display 210. By way of example and not limitation, network interface 208 may communicate data over a local-area-network (LAN), a wireless local-area-network (WLAN), a personal-area-network (PAN), a wide-area-network (WAN), an intranet, the Internet, a peer-to-peer network, point-to-point network, a mesh network, and the like.

Radar-based gesture recognition system 102, as noted above, is configured to sense gestures. To enable this, radar-based gesture recognition system 102 includes a radar-emitting element 212, an antenna element 214, analog-to-digital converter 216, and a signal processor 218.

Generally, radar-emitting element 212 is configured to provide a radar field, in some cases one that is configured to penetrate fabric or other obstructions and reflect from human tissue. These fabrics or obstructions can include wood, glass, plastic, cotton, wool, nylon and similar fibers, and so forth, while reflecting from human tissues, such as a person's hand. In some cases, the radar field configuration can be based upon sensing techniques, such as compressed sensing signal recovery, as further described below.

A radar field can be a small size, such as 0 or 1 millimeters to 1.5 meters, or an intermediate size, such as 1 to 30 meters. It is to be appreciated that these sizes are merely for discussion purposes, and that any other suitable range can be used. When the radar field has an intermediate size, antenna element 214 or signal processor 218 are configured to receive and process reflections of the radar field to provide large-body gestures based on reflections from human tissue caused by body, arm, or leg movements, though smaller and more-precise gestures can be sensed as well. Example intermediate-sized radar fields include those in which a user makes gestures to control a television from a couch, change a song or volume from a stereo across a room, turn off an oven or oven timer (a near field would also be useful here), turn lights on or off in a room, and so forth.

Radar-emitting element 212 can instead be configured to provide a radar field from little if any distance from a computing device or its display. An example near field is illustrated in FIG. 1 at near radar field 106-1 and is configured for sensing gestures made by a user using a laptop, desktop, refrigerator water dispenser, and other devices where gestures are desired to be made near to the device.

Radar-emitting element 212 can be configured to emit continuously modulated radiation, ultra-wideband radiation, or sub-millimeter-frequency radiation. Radar-emitting element 212, in some cases, is configured to form radiation in beams, the beams aiding antenna element 214 and signal processor 218 to determine which of the beams are interrupted, and thus locations of interactions within the radar field.

Antenna element 214 is configured to receive reflections of, or sense interactions in, the radar field. In some cases, reflections include those from human tissue that is within the radar field, such as a hand or arm movement. Antenna element 214 can include one or many antennas or sensors, such as an array of radiation sensors, the number in the array based on a desired resolution and whether the field is a surface or volume.

Analog-to-digital converter 216 can be configured to capture digital samples of the received reflections within the radar field from antenna element 214 by converting the analog waveform at various points in time to discrete representations. In some cases, analog-to-digital converter 216 captures samples in a manner governed by compressed sensing techniques. For example, some samples are acquired randomly over a data acquisition window, instead of capturing them at periodic intervals, or the samples are captured at a rate considered to be “under-sampled” when compared to the Nyquist-Shannon sampling theorem, as further described below. The number of samples acquired can be a fixed (arbitrary) number for each data acquisition, or can be reconfigured on a capture by capture basis.

Signal processor 218 is configured to process the digital samples using compressed sensing in order to provide data usable to determine a gesture. This can include extracting information from the digital samples, as well as reconstructing a signal of interest, to provide the data. In turn, the data can be used to not only identify a gesture, but additionally differentiate one of the multiple targets from another of the multiple targets generating the reflections in the radar field. These targets may include hands, arms, legs, head, and body, from a same or different person.

The field provided by radar-emitting element 212 can be a three-dimensional (3D) volume (e.g., hemisphere, cube, volumetric fan, cone, or cylinder) to sense in-the-air gestures, though a surface field (e.g., projecting on a surface of a person) can instead be used. Antenna element 214 is configured, in some cases, to receive reflections from interactions in the radar field of two or more targets (e.g., fingers, arms, or persons), and signal processor 218 is configured to process the received reflections sufficient to provide data usable to determine gestures, whether for a surface or in a 3D volume. Interactions in a depth dimension, which can be difficult for some conventional techniques, can be accurately sensed by the radar-based gesture recognition system 102. In some cases, signal processor 218 is configured to extract information from the captured reflections based upon compressed sensing techniques.

To sense gestures through obstructions, radar-emitting element 212 can also be configured to emit radiation capable of substantially penetrating fabric, wood, and glass. Antenna element 214 is configured to receive the reflections from the human tissue through the fabric, wood, or glass, and signal processor 218 configured to analyze the received reflections as gestures, even with received reflections partially affected by passing through the obstruction twice. For example, the radar passes through a layer of material interposed between the radar emitter and a human arm, reflects off the human arm, and then back through the layer of material to the antenna element.

Example radar fields are illustrated in FIG. 1, one of which is near radar field 106-1 emitted by radar-based gesture recognition system 102-1 of desktop computer 104-1. With near radar field 106-1, a user may perform complex or simple gestures with his or her hand or hands (or a device like a stylus) that interrupts the radar field. Example gestures include the many gestures usable with current touch-sensitive displays, such as swipes, two-finger pinch, spread, and rotate, tap, and so forth. Other gestures include can be complex, or simple but three-dimensional, such as the many sign-language gestures, e.g., those of American Sign Language (ASL) and other sign languages worldwide. A few examples of these are: an up-and-down fist, which in ASL means “Yes”; an open index and middle finger moving to connect to an open thumb, which means “No”; a flat hand moving up a step, which means “Advance”; a flat and angled hand moving up and down; which means “Afternoon”; clenched fingers and open thumb moving to open fingers and an open thumb, which means “taxicab”; an index finger moving up in a roughly vertical direction, which means “up”; and so forth. These are but a few of many gestures that can be sensed as well as be mapped to particular devices or applications, such as the advance gesture to skip to another song on a web-based radio application, a next song on a compact disk playing on a stereo, or a next page or image in a file or album on a computer display or digital picture frame.

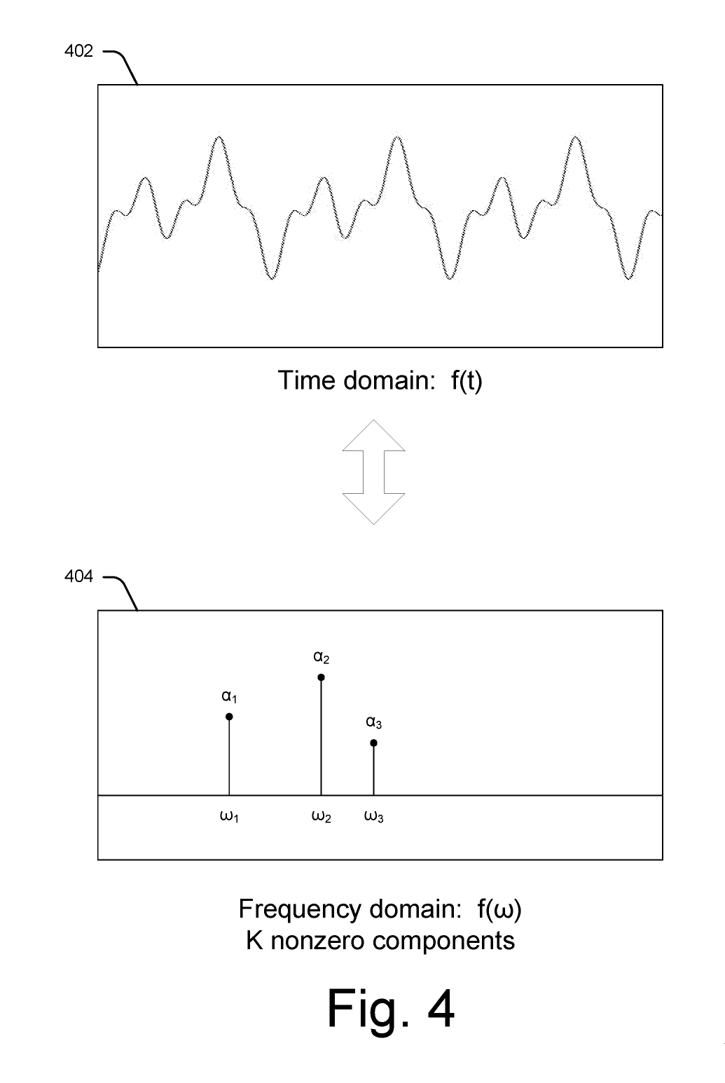

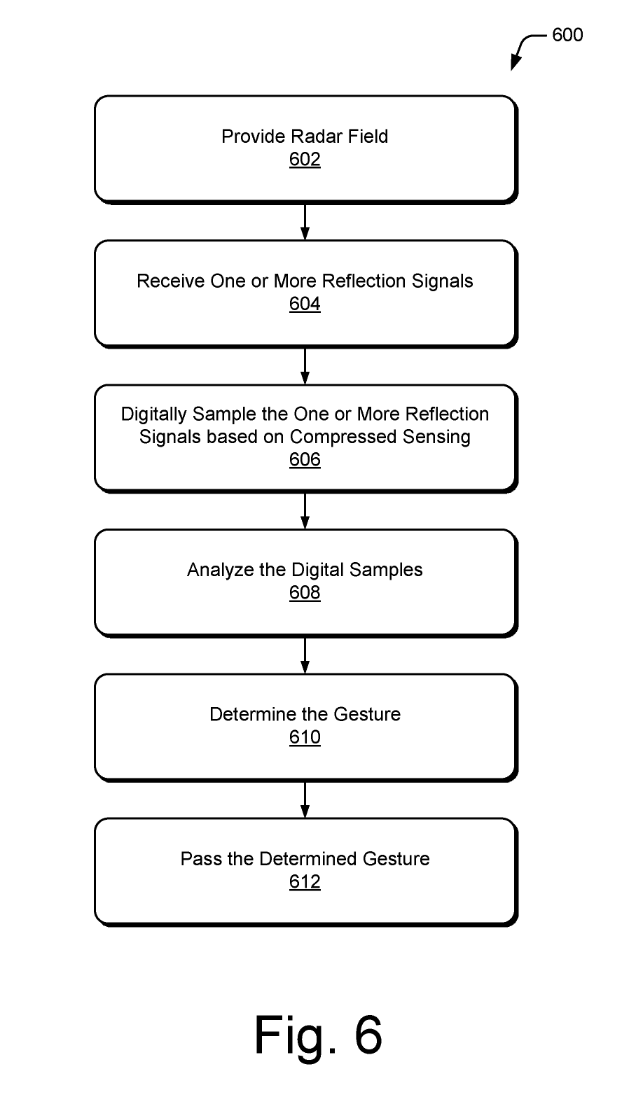

Three example intermediate radar fields are illustrated, the above-mentioned intermediate radar field 106-2 of FIG. 1, as well as two, room-sized intermediate radar fields in FIGS. 4 and 6, which are described below.

Returning to FIG. 2, radar-based gesture recognition system 102 also includes a transmitting device configured to transmit data and/or gesture information to a remote device, though this need not be used when radar-based gesture recognition system 102 is integrated with computing device 104. When included, data can be provided in a format usable by a remote computing device sufficient for the remote computing device to determine the gesture in those cases where the gesture is not determined by radar-based gesture recognition system 102 or computing device 104.

In more detail, radar-emitting element 212 can be configured to emit microwave radiation in a 1 GHz to 300 GHz range, a 3 GHz to 100 GHz range, and narrower bands, such as 57 GHz to 63 GHz, to provide the radar field. This range affects antenna element 214's ability to receive interactions, such as to follow locations of two or more targets to a resolution of about two to about 25 millimeters. Radar-emitting element 212 can be configured, along with other entities of radar-based gesture recognition system 102, to have a relatively fast update rate, which can aid in resolution of the interactions.

By selecting particular frequencies, radar-based gesture recognition system 102 can operate to substantially penetrate clothing while not substantially penetrating human tissue. Further, antenna element 214 or signal processor 218 can be configured to differentiate between interactions in the radar field caused by clothing from those interactions in the radar field caused by human tissue. Thus, a person wearing gloves or a long sleeve shirt that could interfere with sensing gestures with some conventional techniques, can still be sensed with radar-based gesture recognition system 102. Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Radar-based gesture recognition system 102 may also include one or more system processors 222 and system media 224 (e.g., one or more computer-readable storage media). System media 224 includes system manager 226, which can perform various operations, including determining a gesture based on data from signal processor 218, mapping the determined gesture to a pre-configured control gesture associated with a control input for an application associated with remote device 108, and causing transceiver 218 to transmit the control input to the remote device effective to enable control of the application (if remote). This is but one of the ways in which the above-mentioned control through radar-based gesture recognition system 102 can be enabled. Operations of system manager 226 are provided in greater detail as part of methods 600 and 800 below.

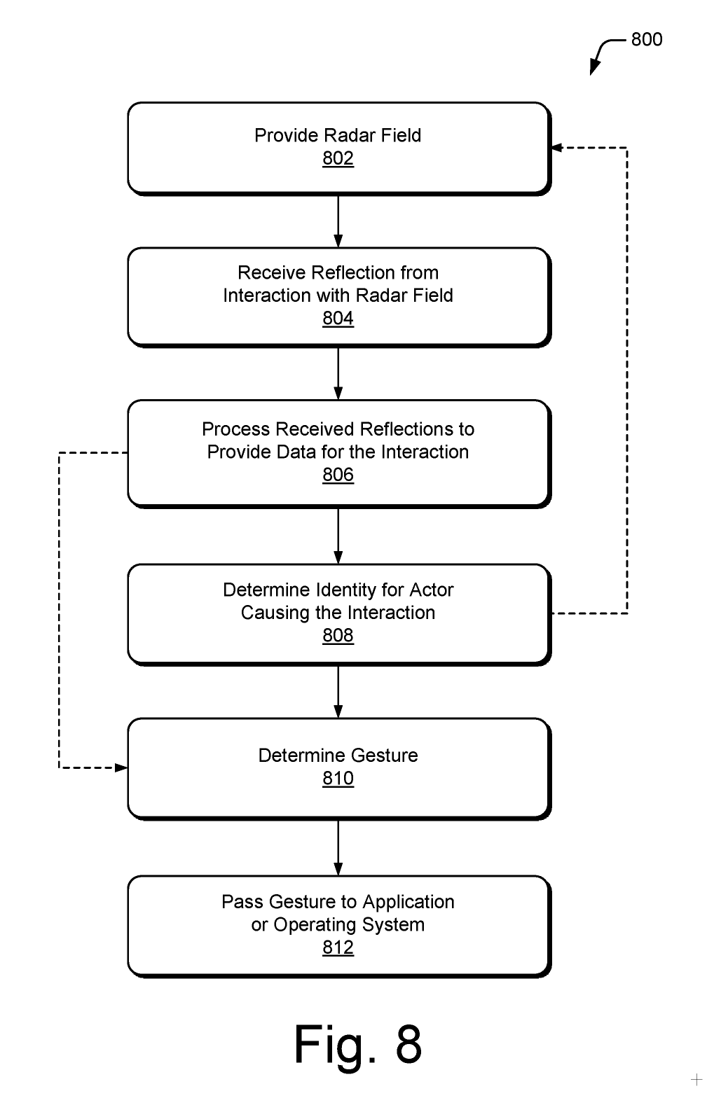

These and other capabilities and configurations, as well as ways in which entities of FIGS. 1 and 2 act and interact, are set forth in greater detail below. These entities may be further divided, combined, and so on. The environment 100 of FIG. 1 and the detailed illustrations of FIGS. 2 and 8 illustrate some of many possible environments and devices capable of employing the described techniques.

Compressed Sensing

Various systems and environments described above transmit an outgoing radar field, and subsequently process incoming (resultant) signals to determine gestures performed in-the-air. In general, signal processing entails the transformation or modification of a signal in order to extract various types of information. Analog signal processing operates on continuous (analog) waveforms using analog tools, such as hardware components that perform the various modifications or transformations (e.g., filtering, frequency mixing, amplification, attenuation, etc.) to obtain information from the waveforms. Conversely, digital signal processing captures discrete values that are representative of the analog signal at respective points in time, and then processes these discrete values to extract the information. Digital signal processing advantageously provides more flexibility, more control over accuracy, lower reproduction costs, and more tolerance to component variations than analog techniques. One form of digital signal processing, referred to here as compressed sensing, involves modeling the signals as a linear system, and subsequently make simplifying assumptions about the linear system to reduce corresponding computations, as further described below. Reducing the complexity of the linear system, and corresponding computations, allows devices to incorporate less complex components than needed by other digital signal processing techniques such as devices using compressed sensing to detect in-the-air gestures via radar fields. In turn, this provides the flexibility to incorporate in-the-air gesture detection via radar fields into a wide variety of products at an affordable price to an end consumer.

Generally speaking, a sampling process captures snapshots of an analog signal at various points in time, such as through the use of an analog-to-digital converter (ADC). An ADC converts a respective voltage value of the analog signal at a respective point in time into a respective numerical value or quantization number. After obtaining the discrete representations of the analog signal, a processing component performs mathematical computations on the captured data samples as a way to extract the desired information. Determining how or when to acquire discrete samples of an analog signal depends upon various factors, such as the frequencies contained within the analog signal, what information is being extracted, what mathematical computations will be performed on the samples, and so forth.

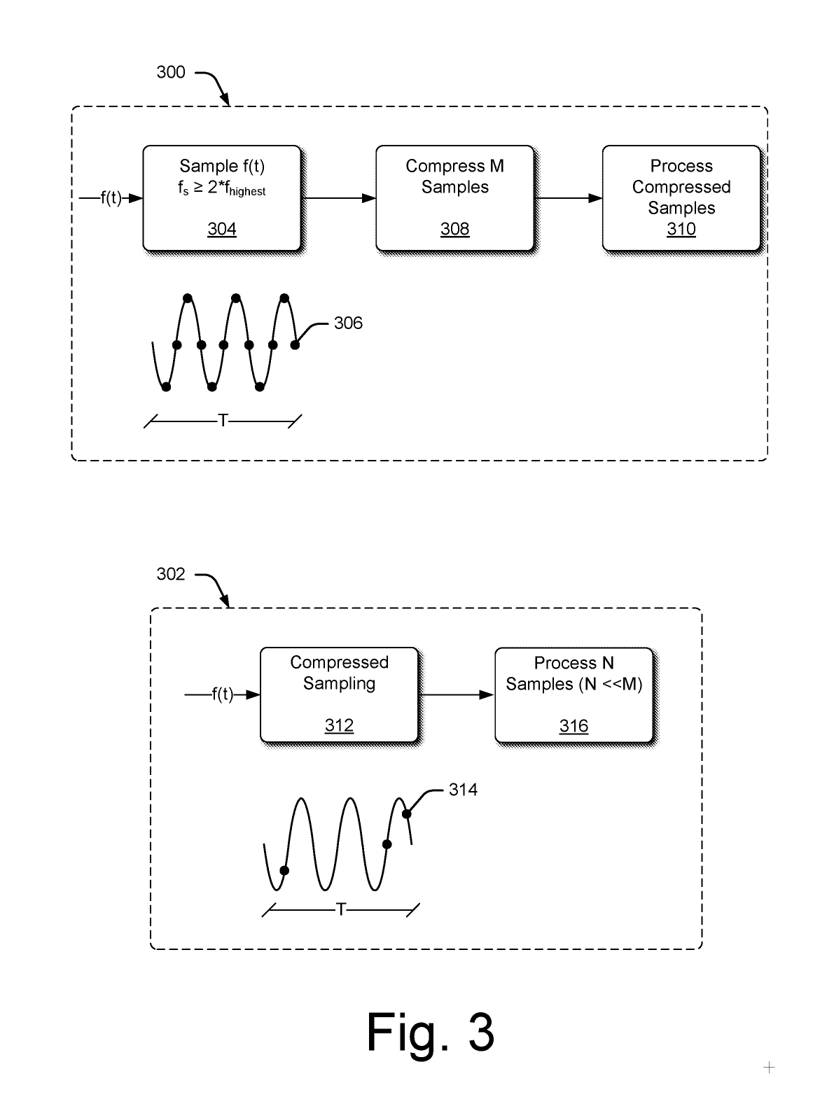

Consider FIG. 3, which illustrates two separate sampling processes applied to a real time signal: f(t). Process 300 depicts a first sampling process based upon the Nyquist-Shannon sampling theorem, while process 302 depicts a second sampling process based upon compressed sensing. For simplicity's sake, f(t) is illustrated in each example as a single frequency sinusoidal waveform, but it is to be appreciated that f(t) can be any arbitrary signal with multiple frequency components and/or bandwidth.

The Nyquist-Shannon sampling theorem establishes a set of conditions or criteria that allow a continuous signal to be sampled at discrete points in time such that no information is lost in the sampling process. In turn, these discrete points can be used to reconstruct the original signal. One criteria states that in order to replicate a signal with a maximum frequency of f_{highest}, the signal must be sampled using a sampling rate of at least a minimum of 2*f_{highest}. Thus, operation 304 samples f(t) at a sampling rate: fₛ≧2*f_{highest}. The Nyquist-Shannon sampling theorem additionally states that these samples be captured at uniform and periodic points in time relative to one another, illustrated by samples 306. Here, operation 304 acquires samples 306 over a finite window of time having a length of T (seconds). The total number of samples, M, can be calculated by: M=T(seconds)*fₛ Hz (Hertz). It is to be appreciated that M, T, and fₛ each represent arbitrary numbers, and can be any suitable value. In this example M=12 samples. However, depending upon the chosen sampling rate, signal being acquired, and data acquisition capture length, these numbers can result in data sizes and/or sampling rates that impact what hardware components are incorporated into a corresponding device.

To further illustrate, consider sampling a 2 GHz radar signal based upon the Nyquist-Shannon sampling theorem. Referring to the above discussion, a 2 GHz radar signal results in fₛ≧4 GHz. Over a T=1 second window, this results in at least: M=T*fₛ=1.0*4×10⁹=4×10⁹ samples. Accordingly, a device that utilizes sampling rates and data acquisitions of this size needs the corresponding hardware to support them (e.g., a type of ADC, memory storage size, processor speed, etc.). Some devices have additional criteria to capture and process data in “real-time”, which can put additional demands on the type of hardware used by the devices. Here, the term “real-time” implies that the time delay generated by processing a first set of data (such as the samples over a capture window of length T as described above) is small enough to give the perception that the processing occurs (and completes) simultaneously with the data capture. It can therefore be desirable to reduce the amount of data early in the information extraction process as a way to reduce computations.

Operation 308 compresses the M samples, which can be done by applying one or more data compression algorithms, performing digital down conversion, and so forth. In turn, operation 310 processes the compressed samples to extract the desired information. While data compression algorithms can be used to reduce the amount of data that is processed for a signal, M samples are still captured, and the compression/data reduction is performed on these M samples. Thus, when applying the Nyquist-Shannon sampling theorem to radar signals, such as those used to detect in-the-air gestures, the corresponding device has the criteria of incorporating an ADC capable of capturing samples at a high sampling rate, including memory with room to store the initial M samples, and utilizing a processor with adequate resources to perform the compression process and other computations within certain time constraints.

Compressed sensing (also known as compressive sampling, sparse sampling, and compressive sensing) provides an alternative to Nyquist-Shannon based digital signal processing. Relative to the Nyquist-Shannon sampling theorem, compressed sensing uses lower sampling rates for a same signal, resulting in fewer samples over a same period of time. Accordingly, devices that employ compressed sensing to detect in-the-air gestures via radar fields and/or radar signals can incorporate less complex and less expensive components than those applying signal processing based on the Nyquist-Shannon sampling theorem.

Process 302 depicts digital signal processing of f(t) using compressed sensing. As in the case of process 300, process 302 begins by sampling f(t) to obtain discrete digital representations of f(t) at respective points in time. However, instead of first capturing samples and then compressing them (e.g., operation 304 and operation 308 of process 300), operation 312 compresses the sampling process. In other words, compression occurs as part of the data capture process, which results in fewer samples being initially acquired and stored over a capture window. This can be seen by comparing samples 306 generated during the sampling process at operation 304 (M=16 samples) and samples 314 generated by the sampling process at operation 312 (N=3 samples), where N<<M.

Upon capturing compressed samples, operation 316 processes the N samples to extract the desired information from or about f(t). In some cases, measurements or sensing matrices are used to extract the information or reconstruct a signal of interest from f(t). At times, the models used to generate the applied measurements or sensing matrices influence the sampling process. For instance, as discussed above, samples 306 are periodic and uniformly spaced from one another in time. Conversely, samples 314 have a random spacing relative to one another based upon their compressed nature and the expected data extraction and/or reconstruction process. Since compressed sensing captures fewer samples than its Nyquist-Shannon based counterpart, a device using compressed sensing can incorporate less complicated components, as further discussed above. This reduction in samples can be attributed, in part, to how a corresponding system is modeled and simplified.

Sparsity Based Compressed Sensing

Generally speaking, signals, or a system in which these signals reside, can be modeled as a linear system. Modeling signals and systems help isolate a signal of interest by incorporating known information as a way to simplify computations. Linear systems have the added benefit in that linear operators can be used to transform or isolate different components within the system. Compressed sensing uses linear system modeling, and the additional idea that a signal can be represented using only a few non-zero coefficients, as a way to compress the sampling process, as further described above and below.

First consider a simple system generally represented by the equation:

y=Ax (1)

where y represents an output signal, x represents an input signal, and A represents the transformation or system applied to x that yields y. As a linear system, this equation can be alternately described as a summation of simpler functions or vectors. Mathematically, this can be described as:

$${y}_{1} = {A}_{1 , 1} {x}_{1} + {A}_{1 , 2} {x}_{2} + … + {A}_{1 , m} {x}_{m} \\ {y}_{2} = {A}_{2 , 1} {x}_{1} + {A}_{2 , 2} {x}_{2} + … + {A}_{2 , m} {x}_{m} \\ ⋮ \\ {y}_{n} = {A}_{n , 1} {x}_{1} + {A}_{n , 2} {x}_{2} + … + {A}_{n , m} {x}_{m} \qquad ( 2 )$$

In matrix form, this becomes:

$$[ \begin{matrix}{y}_{1} & … & {y}_{n}\end{matrix} ] = [ \begin{matrix}{A}_{1 , 1} & … & {A}_{1 , m} \\ ⋮ & ⋱ & ⋮ \\ {A}_{n , 1} & … & {A}_{n , m}\end{matrix} ] [ \begin{matrix}{x}_{1} & … & {x}_{m}\end{matrix} ] \qquad ( 3 )$$

Now consider the above case where a device first transmits an outgoing radar field, then receives resultant or returning signals that contain information about objects in the corresponding area, such as in-the-air gestures performed in the radar field. Applying this to equation (3) above, the resultant or returning signals received by the device can be considered the output signal [y₁ . . . yₙ] of a system, and [x₁ . . . xₘ] becomes the signal of interest. [A_{1,1}, . . . A_{m,m}] represent the transformation that, when applied to [x₁ . . . xₘ], yields [y₁ . . . yₙ]. Here, [y₁ . . . yₙ] is known, and [x₁ . . . xₘ] is unknown. To determined [x₁ . . . xₘ], the equation becomes:

$$[ \begin{matrix}{y}_{1} & … & {y}_{n}\end{matrix} ] = {[ \begin{matrix}{A}_{1 , 1} & … & {A}_{1 , m} \\ ⋮ & ⋱ & ⋮ \\ {A}_{n , 1} & … & {A}_{n , m}\end{matrix} ]}^{- 1} = [ \begin{matrix}{x}_{1} & … & {x}_{m}\end{matrix} ] \qquad ( 4 )$$

Equation (4) provides a formula for solving variables [x₁ . . . xₘ]. Generally speaking, if there are more unknowns than variables to be solved, the system of linear equations have an undetermined number of solutions. Therefore, it is useful to use as much known information available to help simplify the system in order to arrive at a determinate solution. Some forms of compressed sensing use transform coding (and sparsity) as a simplification technique. Transform coding builds upon the notion of finding a basis or set of vectors that provide a sparse (or compressed) representation of a signal. For the purposes of this discussion, a sparse or compressed representation of a signal refers to a signal representation that, for a signal having length n samples, can be described using k coefficients, where k<<n.

To further illustrate, consider FIG. 4, which depicts signal f(t) in its corresponding time domain representation (graph 402), and its corresponding frequency domain representation (graph 404). Here, f(t) is a summation of multiple sinusoidal functions, whose instantaneous value varies continuously over time. Subsequently, no one value can be used to express f(t) in the time domain. Now consider f(t) when alternately represented in the frequency domain: f(ω). As can be seen by graph 404, f(ω) has three discrete values: α₁ located at ω₁, α₂ located at ω₂., and α₃ at ω₃. Thus, using a general view where

$$[ \begin{matrix}{ω}_{1} \\ {ω}_{2} \\ {ω}_{3}\end{matrix} ]$$

is considered as basis vector, f(ω) can be expressed as:

f(ω)=[α₁α₂α₃] (5)

While this example illustrates a signal represented in the frequency domain using one basis vector, it is to be appreciated that this is merely for discussion purposes, and that other domains can be used to represent a signal using one or more basis vectors.

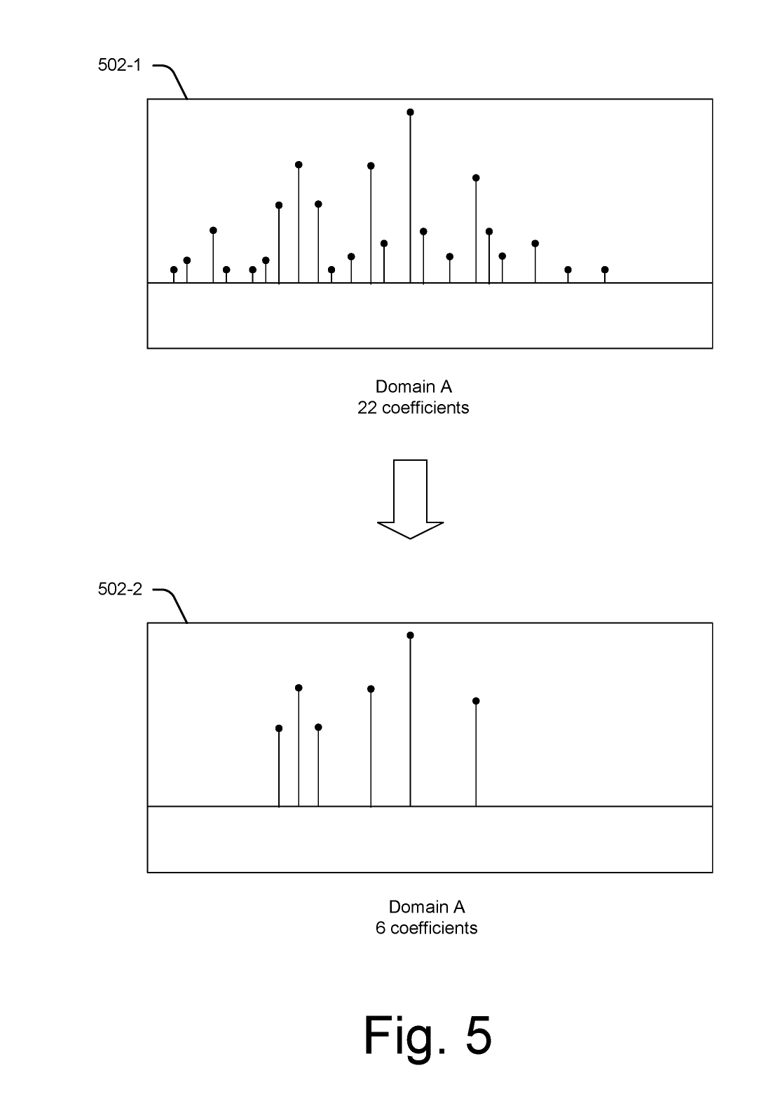

Ideally, a signal can be exactly expressed using a finite and determinate representation. For instance, in the discussion above, f(ω) can be exactly expressed with three coefficients when expressed with the proper basis vector. Other times, the ideal or exact signal representation may contain more coefficients than are desired for processing purposes. FIG. 5 illustrates two separate representations of an arbitrary signal in an arbitrary domain, generically labeled here as domain A. Graph 502-1 illustrates an exact representation of the arbitrary signal, which uses 22 coefficients related to one or more corresponding basis vectors to represent the arbitrary signal. While some devices may be well equipped to process this exact representation, other devices may not. Therefore, it can be advantageous to reduce this number by approximating the signal. A sparse approximation of the arbitrary signal preserves only the values and locations of the largest coefficients that create an approximate signal within a defined margin of error. In other words, the number of coefficients kept, and the number of coefficients zeroed out, can be determined by a tolerated level of error in the approximation. Graph 502-2 illustrates a sparse approximation of the arbitrary signal, which uses six coefficients for its approximation, rather than the twenty-two coefficients used in the ideal representation. To build upon equation (5) above, and to again simplify for discussion purposes, this simplification by approximation mathematically looks like:

Exact signal representation=[α₁α₂ . . . α₂₁α₂₂] (6)

Approximate signal representation=[0α₂ . . . 0α₂₂] (7)

where the chosen coefficients elements within the approximate signal representation are zeroed out. Further, computations performed with these zeroed out elements, such as inner-product operations of a matrix, become simplified. Thus, a sparse representation of a signal can be an exact representation, or an approximation of a signal.

Applying this to compressed sensing, recall that signal processing techniques perform various transformations and modifications to signals as a way to extract information about a signal of interest. In turn, how a signal is captured, transformed, and modified to collect the information is based upon how the system is modeled, and the signal under analysis. As one skilled in these techniques will appreciate, the above described models provide a way to extract information about a signal of interest using less samples than models using Nyquist-Shannon based sampling by making assumptions about the signals of interest and their sparsity. In turn, these assumptions and techniques provide theorems and guidelines to design one or more sensing matrices (e.g., the A matrices as seen in equation (4) above) as a way for signal recovery and/or measurement extraction. In other words, by carefully constructing A, the system can extract the desired information or recover signal x. The generation of A can be based upon any suitable algorithm. For example, various l₁ minimization techniques in the Laplace space can be used to recover an approximation of x based, at least in part, on assuming x is a sparse signal. Greedy algorithms can alternately be employed for signal recovery, where optimizations are made during each iteration until a convergence criterion is met or optimal solution is determined. It is to be appreciated that these algorithms are for illustrative purposes, and that other algorithms can be used to generate a sensing or measurement matrix. At times, these techniques impose additional restrictions on data acquisition, such as the number of samples to acquire, the randomness or periodicity between acquired samples, etc. Parts or all these measurement matrices can be generated and stored prior to the data acquisition process. Once generated, the various sensing matrices can be stored in memory of a corresponding device for future use and application. In the case of a device that senses in-the-air gestures using radar fields, the size of storing sensing and/or measurement matrices in memory consumes less memory space than storing samples based upon Nyquist-Shannon sampling. Depending upon the size and number of the applied matrices, the inner-product computations associated with these applying these various matrices additionally use less processing power. Thus, the lower sampling rates and less processing associated with compressed sensing can be advantageous for in-the-air gesture detection via radar fields, since it reduces the complexity, and potentially size, of the components that can be used to sample and process the radar fields. In turn, this allows more devices to incorporate gesture detection via radar fields due to the lower cost and/or smaller size of the components.

Example Methods

FIGS. 6 and 8 depict methods enabling radar-based gesture recognition using compressed sensing. Method 600 identifies a gesture by transmitting a radar field, and using compressed sampling to capture reflected signals generated by the gesture being performed in the radar field. Method 800 enables radar-based gesture recognition through a radar field configured to penetrate fabric but reflect from human tissue, and can be used separate from, or in conjunction with in whole or in part, method 600.

These methods are shown as sets of blocks that specify operations performed but are not necessarily limited to the order or combinations shown for performing the operations by the respective blocks. In portions of the following discussion reference may be made to environment 100 of FIG. 1 and as detailed in FIG. 2, reference to which is made for example only. The techniques are not limited to performance by one entity or multiple entities operating on one device.

At 602 a radar field is provided. This radar field can be caused by one or more of gesture manager 206, system manager 226, or signal processor 218. Thus, system manager 226 may cause radar-emitting element 212 of radar-based gesture recognition system 102 to provide (e.g., project or emit) one of the described radar fields noted above.

At 604, one or more reflected signals are received. These reflected signals can be signal reflections generated by an in-the-air gesture performed in-the radar field provided at 602. This can include receiving one reflected signal, or multiple reflected signals. In the case of devices incorporating radar-based gesture recognition system 102, these reflected signal can be received using antenna element 214 and/or a transceiver 218.

At 606, the one or more reflected signals are digitally sampled based on compressed sensing, as further described above. When using compressed sensing, the sampling process can capture a fixed number of samples at random intervals over a data acquisition window (e.g., samples 314), rather than periodic and uniform intervals (e.g., samples 306). The number of acquired samples, as well as the data acquisition window, can be determined or based upon what information is being extracted or what signal is being reconstructed from the samples.

At 608, the digital samples are analyzed based upon compressed sensing. In some cases, the analyzing applies sensing matrices or measurement vectors to reconstruct or extract desired information about a signal of interest. These matrices or vectors can be predetermined and stored in memory of the devices incorporating radar-based gesture recognition system 102. In these cases, the analysis would access the memory of the system to retrieve the corresponding sensing matrices and/or measurement matrices. Other times, they are computed during the analysis process.

At 610, the gesture is determined using the extracted information and/or the reconstructed signal of interest, as further described above and below. For example, the gesture can be determined by mapping characteristics of the gesture to pre-configured control gestures. To do so, all or part of the extracted information can be passed to gesture manager 206.

At 612, the determined gesture is passed effective to enable the interaction with the radar field to control or otherwise interact with a device. For example, method 600 may pass the determined gesture to an application or operating system of a computing device effective to cause the application or operating system to receive an input corresponding to the determined gesture.

Returning to the example of a pre-configured gesture to turn up a volume, the person's hand is identified at 608 responsive to the person's hand or the person generally interacting with a radar field to generate the reflected waves received at 604. Then, on sensing an interaction with the radar field at 608, gesture manager determines at 610 that the actor interacting with the radar field is the person's right hand and, based on information stored for the person's right hand as associated with the pre-configured gesture, and determines that the interaction is the volume-increase gesture for a television. On this determination, gesture manager 206 passes the volume-increase gesture to the television at 612, effective to cause the volume of the television to be increased.

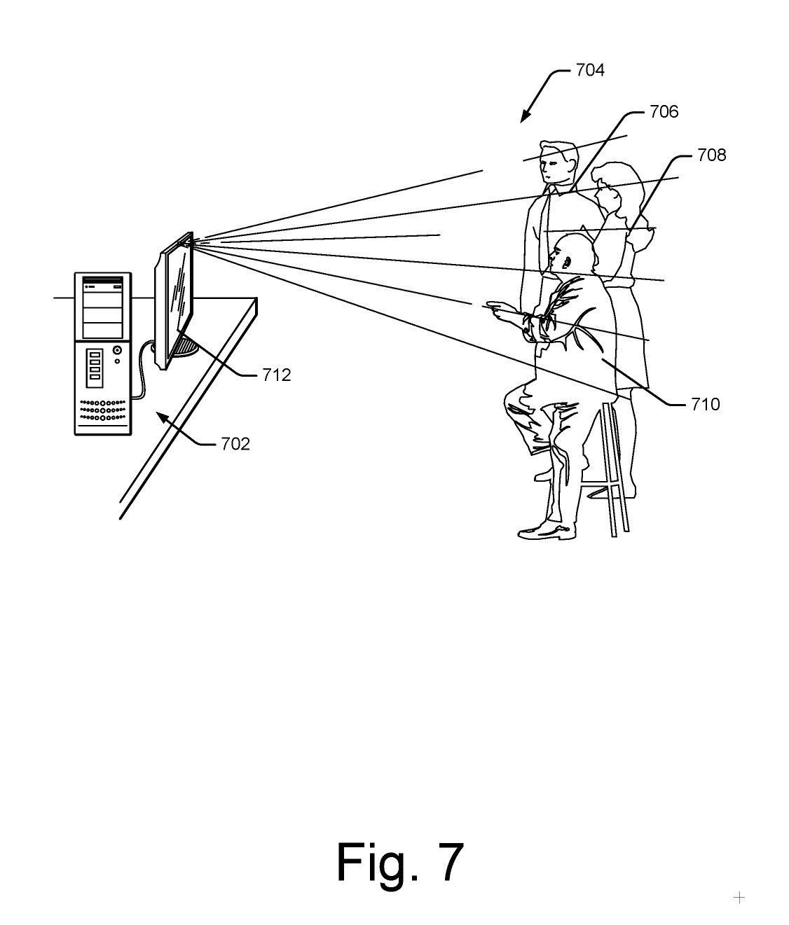

By way of further example, consider FIG. 7, which illustrates a computing device 702, a radar field 704, and three persons, 706, 708, and 710. Each of persons 706, 708, and 710 can be an actor performing a gesture, though each person may include multiple actors—such as each hand of person 710, for example. Assume that person 710 interacts with radar field 704, which is sensed at operation 604 by radar-based gesture recognition system 102, here through reflections received by antenna element 214 (shown in FIGS. 1 and 2). For this initial interaction person 710 may do little if anything explicitly, though explicit interaction is also permitted. Here person 710 simply walks in and sits down on a stool and by so doing walks into radar field 704. Antenna system 214 senses this interaction based on received reflections from person 710.

Radar-based gesture recognition system 102 determines information about person 710, such as his height, weight, skeletal structure, facial shape and hair (or lack thereof). By so doing, radar-based gesture recognition system 102 may determine that person 710 is a particular known person or simply identify person 710 to differentiate him from the other persons in the room (persons 706 and 708), performed at operation 610. After person 710's identity is determined, assume that person 710 gestures with his left hand to select to change from a current page of a slideshow presentation to a next page. Assume also that other persons 706 and 708 are also moving about and talking, and may interfere with this gesture of person 710, or may be making other gestures to the same or other applications, and thus identifying which actor is which can be useful as noted below.

Concluding the ongoing example of the three persons 706, 708, and 710 of FIG. 7, the gesture performed by person 710 is determined by gesture manager 206 to be a quick flip gesture (e.g., like swatting away a fly, analogous to a two-dimensional swipe on a touch screen) at operation 612. At operation 614, the quick flip gesture is passed to a slideshow software application shown on display 712, thereby causing the application to select a different page for the slideshow. As this and other examples noted above illustrate, the techniques may accurately determine gestures, including for in-the-air, three dimensional gestures and for more than one actor.

Method 800 enables radar-based gesture recognition through a radar field configured to penetrate fabric or other obstructions but reflect from human tissue. Method 800 can work with, or separately from, method 600, such as to use a radar-based gesture recognition system to provide a radar field and sense reflections caused by the interactions described in method 600. Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

At 802, a radar-emitting element of a radar-based gesture recognition system is caused to provide a radar field, such as radar-emitting element 212 of FIG. 2. This radar field, as noted above, can be a near or an intermediate field, such as from little if any distance to about 1.5 meters, or an intermediate distance, such as about 1 to about 30 meters. By way of example, consider a near radar field for fine, detailed gestures made with one or both hands while sitting at a desktop computer with a large screen to manipulate, without having to touch the desktop's display, images, and so forth. The techniques enable use of fine resolution or complex gestures, such as to “paint” a portrait using gestures or manipulate a three-dimensional computer-aided-design (CAD) images with two hands. As noted above, intermediate radar fields can be used to control a video game, a television, and other devices, including with multiple persons at once.

At 804, an antenna element of the radar-based gesture recognition system is caused to receive reflections for an interaction in the radar field. Antenna element 214 of FIG. 2, for example, can receive reflections under the control of gesture manager 206, system processors 222, or signal processor 218.

At 806, the reflection signal is processed to provide data for the interaction in the radar field. For instance, devices incorporating radar-based gesture recognition system 102 can digitally sample the reflection signal based upon compressed sensing techniques, as further described above. The digital samples can be processed by signal processor 218 to extract information, which may be used to provide data for later determination of the intended gesture performed in the radar field (such as by system manager 226 or gesture manager 206). Note that radar-emitting element 212, antenna element 214, and signal processor 218 may act with or without processors and processor-executable instructions. Thus, radar-based gesture recognition system 102, in some cases, can be implemented with hardware or hardware in conjunction with software and/or firmware.

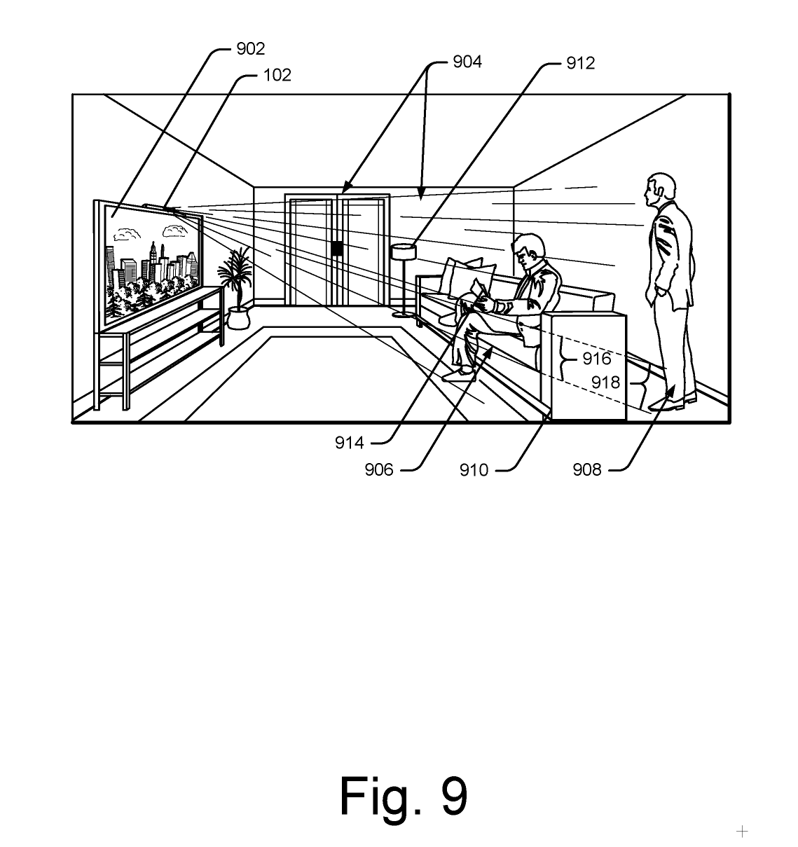

By way of illustration, consider FIG. 9, which shows radar-based gesture recognition system 102, a television 902, a radar field 904, two persons 906 and 908, a couch 910, a lamp 912, and a newspaper 914. Radar-based gesture recognition system 102, as noted above, is capable of providing a radar field that can pass through objects and clothing, but is capable of reflecting off human tissue. Thus, radar-based gesture recognition system 102, at operations 802, 804, and 806, generates and senses gestures from persons even if those gestures are obscured, such as a body or leg gesture of person 908 behind couch 910 (radar shown passing through couch 910 at object penetration lines 916 and continuing at passed through lines 918), or a hand gesture of person 906 obscured by newspaper 914, or a jacket and shirt obscuring a hand or arm gesture of person 906 or person 908. Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

At 808, an identity for an actor causing the interaction is determined based on the provided data for the interaction. This identity is not required, but determining this identity can improve accuracy, reduce interference, or permit identity-specific gestures as noted herein. As described above, a user may have control over whether user identity information is collected and/or generated.

After determining the identity of the actor, method 800 may proceed to 802 to repeat operations effective to sense a second interaction and then a gesture for the second interaction. In one case, this second interaction is based on the identity of the actor as well as the data for the interaction itself. This is not, however, required, as method 800 may proceed from 806 to 810 to determine, without the identity, a gesture at 810.

At 810 the gesture is determined for the interaction in the radar field. As noted, this interaction can be the first, second, or later interactions and based (or not based) also on the identity for the actor that causes the interaction.

Responsive to determining the gesture at 810, the gesture is passed, at 812, to an application or operation system effective to cause the application or operating system to receive input corresponding to the determined gesture. By so doing, a user may make a gesture to pause playback of media on a remote device (e.g., television show on a television), for example. In some embodiments, therefore, radar-based gesture recognition system 102 and these techniques act as a universal controller for televisions, computers, appliances, and so forth.

As part of or prior to passing the gesture, gesture manager 206 may determine for which application or device the gesture is intended. Doing so may be based on identity-specific gestures, a current device to which the user is currently interacting, and/or based on controls through which a user may interaction with an application. Controls can be determined through inspection of the interface (e.g., visual controls), published APIs, and the like.

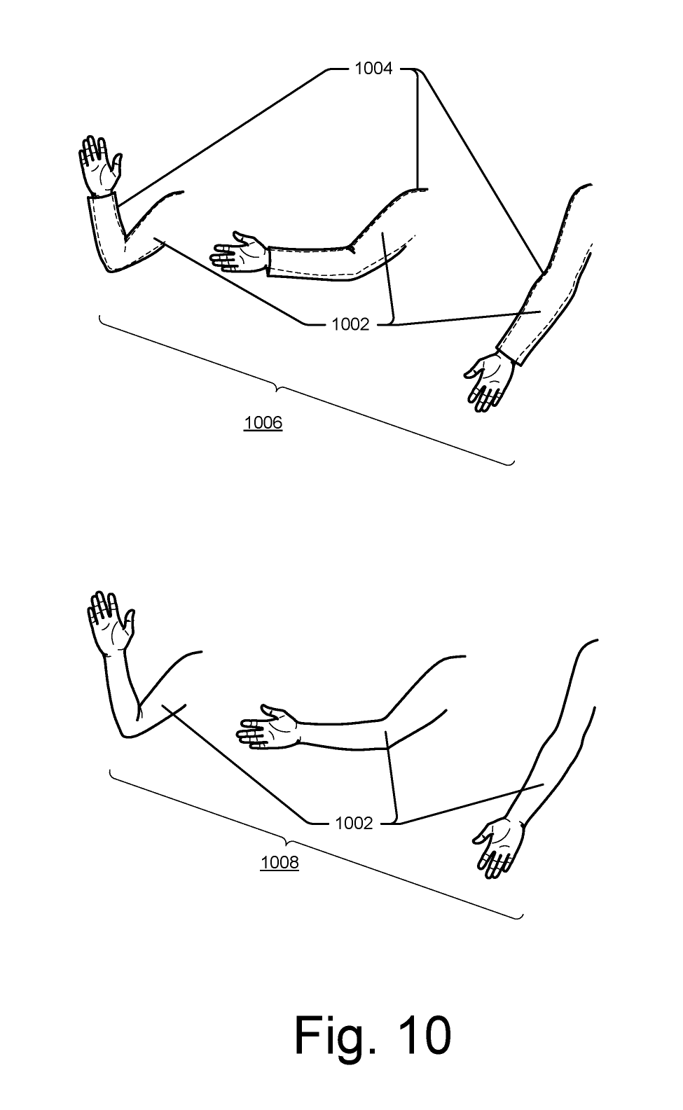

As noted in part above, radar-based gesture recognition system 102 provides a radar field capable of passing through various obstructions but reflecting from human tissue, thereby potentially improving gesture recognition. Consider, by way of illustration, an example arm gesture where the arm performing the gesture is obscured by a shirt sleeve. This is illustrated in FIG. 10, which shows arm 1002 obscured by shirt sleeve 1004 in three positions at obscured arm gesture 1006. Shirt sleeve 1004 can make more difficult or even impossible recognition of some types of gestures with some convention techniques. Shirt sleeve 1004, however, can be passed through and radar reflected from arm 1002 back through shirt sleeve 1004. While somewhat simplified, radar-based gesture recognition system 102 is capable of passing through shirt sleeve 1004 and thereby sensing the arm gesture at unobscured arm gesture 1008. This enables not only more accurate sensing of movements, and thus gestures, but also permits ready recognition of identities of actors performing the gesture, here a right arm of a particular person. While human tissue can change over time, the variance is generally much less than that caused by daily and seasonal changes to clothing, other obstructions, and so forth.

In some cases, method 600 or 800 operates on a device remote from the device being controlled. In this case the remote device includes entities of computing device 104 of FIGS. 1 and 2, and passes the gesture through one or more communication manners, such as wirelessly through transceivers and/or network interfaces (e.g., network interface 208 and transceiver 218). This remote device does not require all the elements of computing device 104—radar-based gesture recognition system 102 may pass data sufficient for another device having gesture manager 206 to determine and use the gesture.

Operations of methods 600 and 800 can be repeated, such as by determining for multiple other applications and other controls through which the multiple other applications can be controlled. Methods 800 may then indicate various different controls to control various applications associated with either the application or the actor. In some cases, the techniques determine or assign unique and/or complex and three-dimensional controls to the different applications, thereby allowing a user to control numerous applications without having to select to switch control between them. Thus, an actor may assign a particular gesture to control one specific software application on computing device 104, another particular gesture to control another specific software application, and still another for a thermostat or stereo. This gesture can be used by multiple different persons, or may be associated with that particular actor once the identity of the actor is determined. Thus, a particular gesture can be assigned to one specific application out of multiple applications. Accordingly, when a particular gesture is identified, various embodiments send the appropriate information and/or gesture to the corresponding (specific) application. Further, as described above, a user may have control over whether user identity information is collected and/or generated.

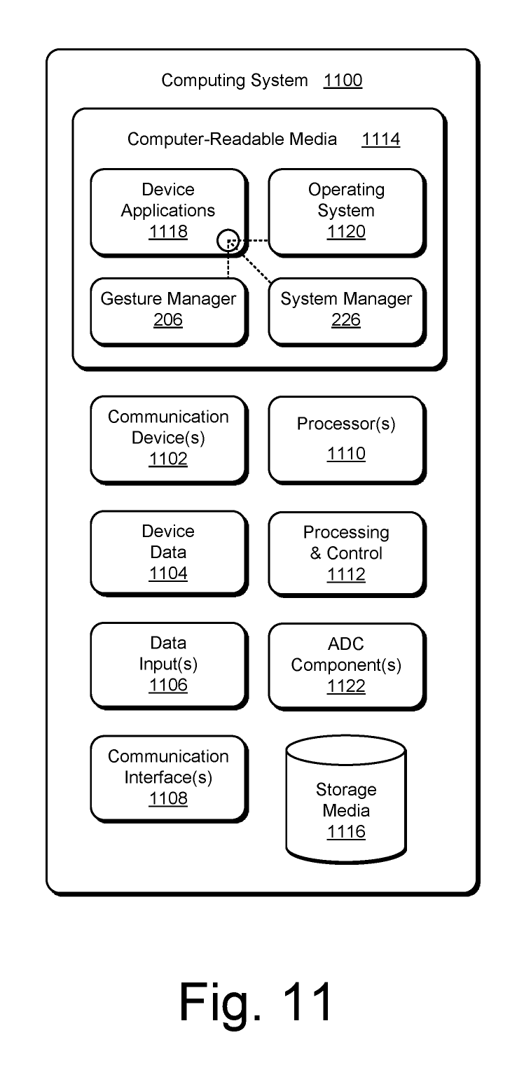

The preceding discussion describes methods relating to radar-based gesture recognition. Aspects of these methods may be implemented in hardware (e.g., fixed logic circuitry), firmware, software, manual processing, or any combination thereof. These techniques may be embodied on one or more of the entities shown in FIGS. 1, 2, 4, 6, and 8 (computing system 800 is described in FIG. 11 below), which may be further divided, combined, and so on. Thus, these figures illustrate some of the many possible systems or apparatuses capable of employing the described techniques. The entities of these figures generally represent software, firmware, hardware, whole devices or networks, or a combination thereof.

Example Computing System

FIG. 11 illustrates various components of example computing system 1100 that can be implemented as any type of client, server, and/or computing device as described with reference to the previous FIGS. 1-10 to implement radar-based gesture recognition using compressed sensing.

Computing system 1100 includes communication devices 1102 that enable wired and/or wireless communication of device data 1104 (e.g., received data, data that is being received, data scheduled for broadcast, data packets of the data, etc.). Device data 1104 or other device content can include configuration settings of the device, media content stored on the device, and/or information associated with a user of the device (e.g., an identity of an actor performing a gesture). Media content stored on computing system 1100 can include any type of audio, video, and/or image data. Computing system 1100 includes one or more data inputs 1106 via which any type of data, media content, and/or inputs can be received, such as human utterances, interactions with a radar field, user-selectable inputs (explicit or implicit), messages, music, television media content, recorded video content, and any other type of audio, video, and/or image data received from any content and/or data source.

Computing system 1100 also includes communication interfaces 1108, which can be implemented as any one or more of a serial and/or parallel interface, a wireless interface, any type of network interface, a modem, and as any other type of communication interface. Communication interfaces 1108 provide a connection and/or communication links between computing system 1100 and a communication network by which other electronic, computing, and communication devices communicate data with computing system 1100.

Computing system 1100 includes one or more processors 1110 (e.g., any of microprocessors, controllers, digital signal processors, and the like), which process various computer-executable instructions to control the operation of computing system 1100 and to enable techniques for, or in which can be embodied, radar-based gesture recognition using compressed sensing. Alternatively, or in addition, computing system 1100 can be implemented with any one or combination of hardware, firmware, or fixed logic circuitry that is implemented in connection with processing and control circuits which are generally identified at 1112. Although not shown, computing system 1100 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Computing system 1100 also includes computer-readable media 1114, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Computing system 1100 can also include a mass storage media device (storage media) 1116.

Computer-readable media 1114 provides data storage mechanisms to store device data 1104, as well as various device applications 1118 and any other types of information and/or data related to operational aspects of computing system 1100, including the sensing or measurement matrices as further described above. As another example, an operating system 1120 can be maintained as a computer application with computer-readable media 1114 and executed on processors 1110. Device applications 1118 may include a device manager, such as any form of a control application, software application, signal-processing and control module, code that is native to a particular device, a hardware abstraction layer for a particular device, and so on. Device applications 1118 also include system components, engines, or managers to implement radar-based gesture recognition, such as gesture manager 206 and system manager 226.

Computing system 1100 also includes ADC component 1122 that converts an analog signal into discrete, digital representations, as further described above. In some cases, ADC component 1122 randomly captures samples over a pre-defined data acquisition window, such as those used for compressed sensing.

### CONCLUSION

Although embodiments of techniques using, and apparatuses including, radar-based gesture recognition using compressed sensing have been described in language specific to features and/or methods, it is to be understood that the subject of the appended claims is not necessarily limited to the specific features or methods described. Rather, the specific features and methods are disclosed as example implementations of radar-based gesture recognition using compressed sensing.

What is claimed is:

1. A computer-implemented method comprising:
providing, by an emitter of a radar system, a radar field;
receiving, at a receiver of the radar system, one or more reflection signals caused by a gesture performed within the radar field;
digitally sampling the one or more reflection signals based, at least in part, on compressed sensing to generate digital samples;
analyzing, using the receiver, the digital samples at least by using one or more sensing matrices to extract information from the digital samples; and
determining the gesture using the information extracted from the digital samples.

2. The computer-implemented method as described in claim 1, wherein analyzing the digital samples further comprises reconstructing an approximation of a signal of interest from the digital samples.

3. The computer-implemented method as described in claim 1, wherein the digitally sampling comprises randomly capturing samples over a data acquisition window to capture N samples, the N samples comprising fewer samples than samples acquired using a Nyquist-Shannon sampling theorem based minimum sampling frequency over the data acquisition window.

4. The computer-implemented method as described in claim 1, wherein the radar field is configured to penetrate fabric but reflect from human tissue.

5. The computer-implemented method as described in claim 1, further comprising determining that the gesture is associated with a remote device and passing the gesture to the remote device.

6. The computer-implemented method as described in claim 1, the determining the gesture using the information extracted from the digital samples further comprising determining the gesture as a gesture performed by a particular actor.

7. The computer-implemented method as described in claim 1, the determining the gesture using the extracted information further comprising differentiating the gesture as being performed by a particular actor out of two or more actors.

8. The computer-implemented method as described in claim 1, further comprising, responsive to determining the gesture, passing the gesture to an application or operating system of a computing device performing the method effective to cause the application or operating system to receive an input corresponding to the gesture.

9. The computer-implemented method as described in claim 1, wherein the analyzing the digital samples further comprises applying an l₁ minimization technique.

10. A computer-implemented method comprising:
providing, using an emitter of a device, a radar field;
receiving, at the device, a reflection signal from interaction with the radar field;
processing, using the device, the reflection signal by:
acquiring N random samples of the reflection signal over a data acquisition window based, at least in part, on compressed sensing; and
extracting information from the N random samples by applying one or more sensing matrices to the N random samples;
determining a gesture associated with the interaction with the radar field; and
responsive to determining the gesture, passing the gesture to an application or operating system.

11. The computer-implemented method as described in claim 10, wherein the determining the gesture further comprises:
determining an identity of an actor causing the interaction with the radar field; and
determining the gesture is a pre-configured control gesture specifically associated with the actor and an application, and the method further comprises passing the pre-configured control gesture to the application effective to cause the application to be controlled by the gesture.

12. The computer-implemented method as described in claim 10, wherein the interaction includes reflections from human tissue having a layer of material interposed between the radar-based gesture recognition system and the human tissue, the layer of material including glass, wood, nylon, cotton, or wool.

13. The computer-implemented method as described in claim 10, the applying one or more sensing matrices to the N random samples further comprising accessing memory of the device to retrieve the one or more sensing matrices.

14. The computer-implemented method as described in claim 10, further comprising:
determining an identity of an actor causing the interaction with the radar field actor from multiple actors at one time; and

15. The computer-implemented method as described in claim 10, wherein passing the gesture to the application or operating system further comprises sending the gesture to a specific application out of multiple applications based upon an assignment of the gesture to the specific application.

16. A radar-based gesture recognition system comprising:
a radar-emitting element configured to provide a radar field;
an antenna element configured to receive reflections generated from interference with the radar field;
an analog-to-digital (ADC) converter configured to capture digital samples based, at least in part, on compressed sensing; and
at least one processor configured to process the digital samples sufficient to determine a gesture associated with the interference by extracting information from the digital samples using one or more sensing matrices.

17. The radar-based gesture recognition system as described in claim 16, the at least one processor further configured to determine the gesture associated with the interference as a pre-configured control gesture associated with a specific application out of multiple applications.

18. The radar-based gesture recognition system as described in claim 16, wherein at least one processor is further configured to reconstruct an approximation of a signal of interest from the digital samples.

19. The radar-based gesture recognition system as described in claim 18, wherein the approximation of the signal of interest is based, at least in part, on assuming a sparse representation of the signal of interest.

20. The radar-based gesture recognition system as described in claim 16, wherein at least one processor is further configured to determine an identity of a particular actor performing the gesture from multiple actors at one time.
